(19) United States
(12) Patent Application Publication
(10) Pub. No.: US 2008/0142207 A1
(43) Pub. Date: Jun. 19, 2008

(54) Heating, ventilation and air conditioning system with temperature mixing in connection with a hot air channel and a cold air channel

(76) Inventors: Michael Friedl, Pulheim (DE); Christoph Capellmann, Wuerselen (DE); Christoph Malig, Erkelenz (DE); Dietmar Zehren, Freudenburg (DE); Markus Matthes, Koeln (DE)

Correspondence Address: FRASER CLEMENS MARTIN & MILLER LLC, 28366 KENSINGTON LANE, PERRYSBURG, OH, 43551, US

(21) Appl. No.: 11/584,359

(22) Filed: Dec. 18, 2006

(51) Int. Cl. B60H 1/00

(52) U.S. Cl. 165/202

(57) ABSTRACT

The invention relates to a device for tempering and ventilating of motor vehicles with an air inlet opening and an air outlet region, wherein air flows are distributed into different vehicle regions. The device is provided with a basic casing, through which a partition extends to divide the flow path of the air from the air inlet opening to the air outlet region into two flow paths. In one flow path, a waste heat exchanger is arranged to heat the air.

### FIELD OF THE INVENTION

The invention relates to a device and a process for tempering air for use in ventilating a passenger compartment of a motor vehicle, such as a heating, ventilation, and air conditioning system.

### BACKGROUND OF THE INVENTION

A heating, ventilation, and air conditioning (HVAC) system for a motor vehicle tempers air for use in a passenger compartment thereof, that is to heat or cool it as required and to ventilate it. For that, the tempered air flows are directed into different regions of the vehicle. External air is fed to the device by a fan and brought to the different areas of the passenger compartment. On its way, the inflowing air is passed over various air treatment devices. The air is cooled on the outside of an evaporator inside the casing of the heating, ventilating, and air conditioning system, and air is heated at an engine waste heat exchanger and, if necessary, at an additional heater. Air outlets lead, for example, into a footwell, an instrument panel, a central and outer regions of the passenger compartment, and to the lower inside of the windscreen through outlets designated as defroster outlets. Ventilation can be realized by circulation of the air of the passenger compartment instead of using the outside air.

Many heating, ventilating, and air conditioning systems have the disadvantage that the hot air and the cold air flow parallel to each other in the mixing region provided. Further, in compact heating, ventilation and air conditioning systems for vehicles, the mixing space for mixing of hot and cold air is very small. Therefore sufficient mixing of the cold air and hot air flows is difficult, which results in unfavourable temperature layering, and undesirable temperature differences between the individual outlets. Accordingly, the hot air, for example, is directed into a flow path which leads to the outlet for the instrument panel and/or footwell regions and the cold air, only just mixed with hot air, arrives at the defroster outlet. That results in that in certain operational modes where the instrument panel region is heated too much, the windscreen is not sufficiently heated and defrosted, and temperature layering occurs in the passenger compartment of the vehicle which is unpleasant for a driver or a passenger.

In order to improve mixing, usually additional guiding elements are provided. Guide vanes can, for example, be provided in flow channels in the heating, ventilating, and air conditioning system or on a temperature door. Elevations or reflecting plates can also be provided on the temperature door. These solutions are disadvantageous in that such guiding elements reduce the air flow, increase noise emission, and increase an overall weight of the heating, ventilating, and air conditioning system.

In commonly owned DE 101 47 114 A1, hereby incorporated herein by reference in its entirety, a device for tempering and ventilating of vehicle compartments is presented which makes possible better mixing of cold and warm air. The device has an air inlet region and an air outlet region, starting from which air flows are distributed into different vehicle regions by a distribution apparatus. The device is provided with a casing configured hollow, through which a partition extends in longitudinal axial direction, which in this embodiment is established as hollow channel for a cross member. The hollow channel divides the air flow path from the air inlet to the air outlet into two flow paths. In one of these flow paths between the hollow channel and the casing wall an engine waste heat exchanger and, if necessary, an additional heater are provided so that the air flowing along this flow path is heated. Downstream of both flow paths there is a temperature door which controls the flow from the cold air flow path and the warm air flow path to the air outlet. The temperature door is designed angled or curved such that at the end stop positions one of both air flow paths is closed and at an intermediate position the air of an air path is, at least partially, laterally or frontally directed into the other air path.

In another embodiment of this device, an essentially U-shaped hot air bypass envelops the casing in the region of the air outlet before the subsequent distribution casing. The hot air bypass with its two U-legs draws hot air over openings from hot air-containing regions of the casing through openings in the casing and thus directs the hot air into a region to be applied with hot air, such as the windscreen, or the defroster outlet. There the hot air is fed through at least one opening at the U-base leg and at least one identical opening in the outer casing. The advantage of this embodiment with hot air bypass is that the bypass is arranged outside the casing so that it does not influence the air flows inside the casing, particularly does not have a negative effect on them by noise emission. Simple in design and manufacture, the hot air bypass allows to take hot air at specific locations and to specifically add hot air into a certain region.

In DE 102 61 036 A1, a heating, ventilating, and air conditioning system casing with an evaporating apparatus and a heating apparatus is disclosed that has a mixing chamber from which air flows to the rear footwell and rear ventilation. This casing is provided with an air control that controls the air flowing through the evaporating apparatus and the heating apparatus into the mixing chamber by means of a mixing door. In addition, the device is provided with a separate layering channel through which cool air can be passed into the rear ventilation region. This device assumes relevant, especially in the summer months. One disadvantage is that for specific temperature control and layering only additional cooling of certain regions is provided. The special requirements of the temperature layering in winter as, for example, the possibility of specific heating of certain regions of the passenger compartment, seem insufficiently considered.

It would be desirable to provide a device for tempering and ventilation of vehicle passenger compartments that makes possible improved mixing of hot and cold air and appropriate temperature stratification with low noise emission.

### SUMMARY OF THE INVENTION

Consistent and consonant with the present invention, a device for tempering and ventilation of vehicle passenger compartments that makes possible improved mixing of hot and cold air and appropriate temperature stratification with low noise emission, has surprisingly been discovered.

According to an embodiment of the invention, improved mixing of cold and hot air and appropriate temperature stratification are reached by that a separate hot air channel running outside the casing around said casing as well as a separate cold air channel inside the unit are provided. The combination according to the invention of a separate hot air channel and a separate cold air channel makes it possible that the hot air flow and the cold air flow run crosswise without penetrating each other. The separate hot air channel draws a portion of the hot air from the air outlet region above the engine waste heat exchanger, directs this hot air in bypass manner around the casing and finally redirects it to an air flow, for example, the air flow for defrosting of the windscreen. The separate cold air channel draws a portion of the cold air from the air outlet region above the evaporator and passes it directly to a region more to be cooled of the vehicle, for example, to the instrument panel outlets, and admixes it below these outlets to the air flow there.

In another embodiment of the invention, the magnitude of the channels is adjustable in order to control the amount of air flowing to the appropriate outlets.

In another embodiment of the invention, the device with the above mentioned combination of a separate hot air channel and a separate cold air channel is supplemented by a temperature door according to DE 101 47 114 A1. This temperature door is arranged downstream of the partition and configured angled or curved in direction of the partition such that at the end stop positions either the hot air flow path, which passes the heat exchanger, or the cold air flow path, which passes above the evaporator, is closed. At an intermediate position the air of an air path is at least partially led into the other air path in each case. In the end, this results in effective mixing and, in combination with the two separate channels, appropriate temperature stratification.

Upstream of the partition, a bent air guide plate can be provided which divides the hot air flow path into an upper and a lower path, thus ensuring that the heat exchanger is homogeneously approached.

Additionally, up to three walls of the additional separate channels are part of the heating, ventilation and air conditioning unit casing and hence made of the same material, whereby an additional covering completes the channels each.

### DESCRIPTION OF THE DRAWINGS

Further details, features and advantages of the invention will become apparent from the following description of examples of embodiment with reference to the accompanying drawings. In the drawings it is shown by:

FIG. 1: the device according to the invention in a sectional side view;

FIG. 2: the device of FIG. 1 with marked flow lines of the hot air flow path and the cold air flow path;

FIG. 3: the device of FIG. 1 in a highly schematized sectional view in the region of the hot air bypass viewed in direction of the cover wall of the bypass; and

FIG. 4: the device of FIG. 1 in a perspective partial lateral top view of the separate hot air channel with the flow course of the hot air in the hot air channel.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

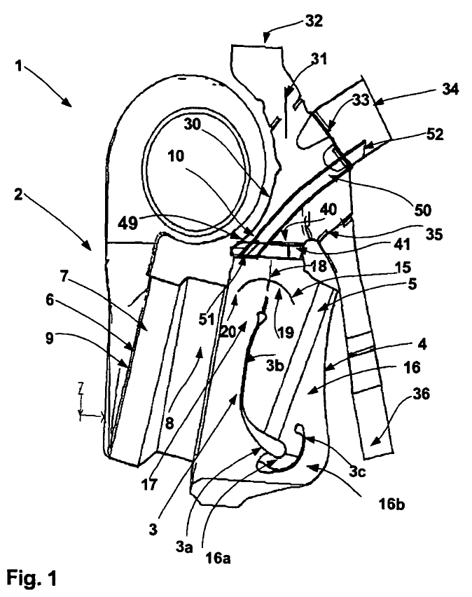

A device 1 according to the invention is provided with a basic casing 2, which is shaped irregular in its outer borders. This basic casing 2 is configured to FIG. 1 as a hollow body, whereby approximately in the centre of the hollow body basic casing 2 a partition 3 is provided extending along the entire basic casing 2. The partition 3 is configured in the lower region 3a as hollow channel with a drop-shaped cross-section so that the partition 3 is rounded in its lower region 3a. In addition, the partition 3 is bent in direction of flow in its lower region 3a.

Between the concave side of the curvature in the lower region 3a of the partition 3 and an outer wall 4 of the casing 2, a heat exchanger 5 such as an engine waste heat exchanger (and, if desired, an additional heater not shown in FIG. 1) is arranged axially extending over the whole length of the casing 2 and ending with the partition 3 and outer wall 4. Favorable results have been obtained where the heat exchanger 5 is arranged approximately parallel to the upper one-wall part 3b of the partition 3. Below the partition 3 there is an air guide plate 3c bent in flow direction which divides the flow path to the heat exchanger 5 into an upper path 16a between the air guide plate 3c and the lower drop-shaped end 3a of the partition 3 and a lower path 16b between the air guide plate 3c and the outer wall 4, which is intended to ensure homogeneous approach to the heat exchanger 5.

Opposite to the heat exchanger 5, i.e. opposite relative to the partition 3, the casing 2 is provided with an air inlet opening 6. The air inlet opening 6 is configured essentially rectangular in top view, whereby the air inlet opening 6 extends box-like from the casing 2 outwards.

In the box-like air inlet opening 6, which is delimited by the box wall 7, an evaporator 8 is arranged in direction of the casing 2 and an upstream filter 9 in direction of the air inlet opening 6. Above the one-wall end 3b of the partition 3 an air outlet region 10 axially extending over the whole length of the casing 2 is provided. The air outlet region 10 is also configured essentially rectangular extending longitudinally.

Above the one-wall end 3b of the partition 3 and between the partition 3 and the air outlet region 10 a temperature door 15 is provided. The partition 3 passing through the casing 2 divides the casing 2 from an air inlet 6 to an air outlet region 10 into a first or hot air flow path 16 provided with the heat exchanger 5 and a second or cold air flow path 17. The temperature door 15 serves to block the hot air flow path 16 or the cold air flow path 17 or to partially open or block both flow paths 16, 17.

The casing 2 and the partition 3 are configured such that the air inflowing according to the air inlet range 6, or the entering air flow, respectively, divides itself and can flow around the partition 3 and parallel re-unites above the partition 3, whereby the casing 2 in direction of the air outlet region 10 above the partition 3 re-tapers, or the flow paths re-narrow.

In the narrowing region above the partition 3 the temperature door 15 is positioned. The temperature door 15 axially extends corresponding with the longitudinal extension of the partition 3 through the whole casing 2, whereby the temperature door 15 includes a shaft 18, on which the temperature door 15 is pivotable. The shaft 18 passes through the axially front-end casing walls of the casing 2 so that the end regions of the shaft 18 of the temperature door 15 protrude from the casing and hence the temperature door 15 can be actuated from outside. The temperature door 15 is designed such that on both sides of the shaft 18 there are door wings 19 of the temperature door 15. The temperature door wings 19 are configured angled, curved or bent to each other such that they include a smaller angle to the partition 3 compared with the angle in direction of the air outlet region 10. Different shapes of the temperature door 15 are conceivable. The temperature door 15 can be configured curved or convex with a C-shape as well as roof-like with flat wings extending outwards, whereby the shaft 18 runs in the region of the ridge. The wing span of the door 15 between the outer longitudinal edges 20 of the door wings 19 is chosen such that at the end stop positions of the door a longitudinal edge 20 of a door wing 19 bears on a casing wall of the casing 2 and the opposite longitudinal edge 20 of the opposite door wing 19 at the end 3b bears at or on the partition 3, respectively. At the end stop positions, hence, the hot air flow path 16 or the cold air flow path 17 are totally blocked so that either only cold air comes into the region of the air outlet region 10 or only hot air comes into the region of the air outlet region 10.

In one embodiment, the temperature door 15 is curved or angled roof-like such that the flow paths, particularly the cold air flow paths 17, are influenced when the temperature door 15 is not at the end stop positions. If the temperature door 15 is opened by an end stop blocking the cold air, a portion of the air flow according to the hot air flow path 16 comes through the heat exchanger 5, i.e. this air flow passes the inner partition 3 in the region 3a, whereas particularly a smaller portion of the cold air according to the cold air flow path 17 in the region above the one-wall end 3b is positively guided around the inner partition 3. So the cold air and the warm air are forced to mix by collision and then guided above the door 15 in direction of the air outlet region 10.

Above the air outlet region 10 a distribution apparatus 30 is provided. This distribution apparatus 30 distributes the air flows over outlets 32, 34, 36 in a channel system. The distribution apparatus 30 is configured essentially box-shaped. Inside the box-shaped structure, in clockwise direction, a defroster outlet 32 blockable with a door 31, an instrument panel outlet 34 adjacently arranged in the box-shaped outlet blockable with a door 33 and a footwell outlet 36 arranged at the underside of the box blockable with a door 35 are established.

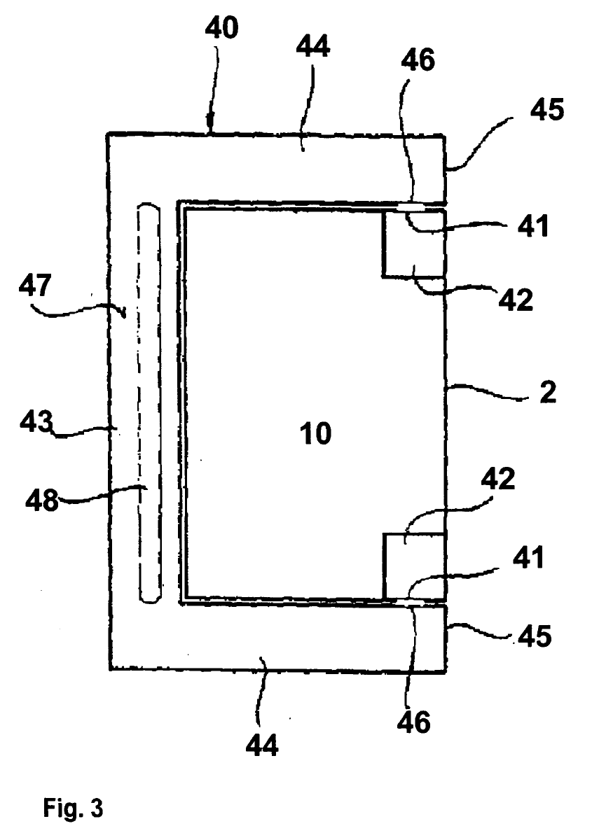

According to the invention, to enrich the air passing through the defroster outlet 32 a separate hot air channel bypass 40 is arranged. The separate hot air channel 40 is positioned in the zone of the air outlet region 10. In the zone of the air outlet region 10 the casing 2 has an approximately rectangular cross-section, whereby in a region approximately above the heat exchanger 5, adjacent to a wall of the casing 2 in direction of the hot air flow path 16, axially at the face-side casing openings 41 are provided in the entering region of the separate hot air channel 40 in the casing wall. It is understood that the channel 40 can be sized or tuned to control the amount of air permitted to flow therethrough. This can be accomplished through hydraulic diameter sizing, orifices (not shown), or tuning valves or dampers (not shown), for example. Above the casing openings 41 guide elements 42 are arranged at the wall of the casing 2. The guide elements 42 pass at least a partial flow of the rising hot air through the casing openings 41. The separate hot air channel 40 is, in its cross-section, configured U-shaped, whereby the separate hot air channel 40 is a U-shaped hollow body. This U-shaped hollow separate hot air channel 40 has, to FIG. 3, a U-base leg 43 and U-legs 44 branching off from the U-base leg 43. The distance between the U-legs 44, or the width of the base leg 43 are dimensioned such that the U-base leg 43 has a length approximately equal to the length of a broad side casing wall, and the length of the U-legs 44 which are arranged approximately rectangular, is approximately equal to the breadth of a narrow face-end casing wall. Adjacent to the outer free edges 45 in the region of the casing openings 41 the separate hot air channel 40 has casing openings 46 flush with the casing openings 41. In an upper cover wall 47 of the base leg 43 the U-base leg 43 has a hot air outlet opening 48 directed upwards corresponding to the flow direction. Above the cover wall 47 a wall of the distribution apparatus 30 adjacent to the cover wall 47 is provided accordingly with identical openings 49. So hot air that flows through the openings 41 and 46 into the U-base leg 43 can flow into the region 32 and mix with the air present.

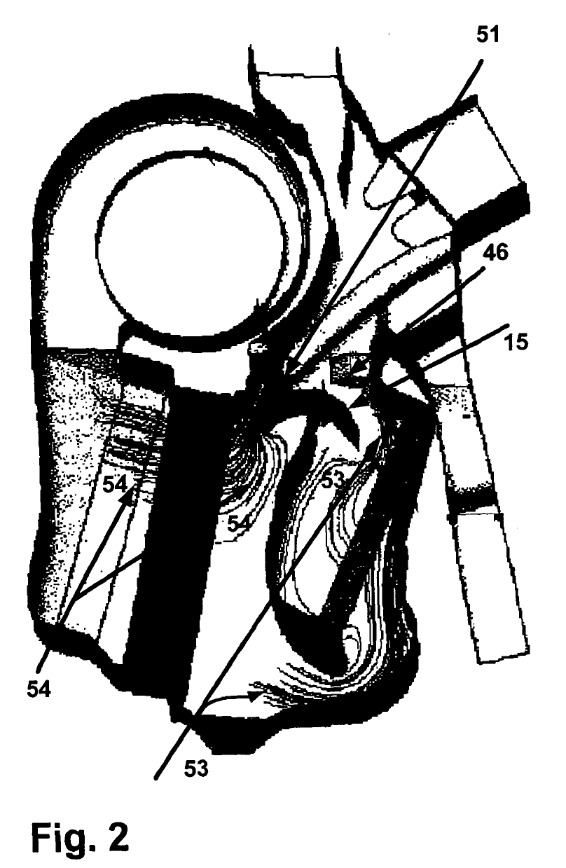

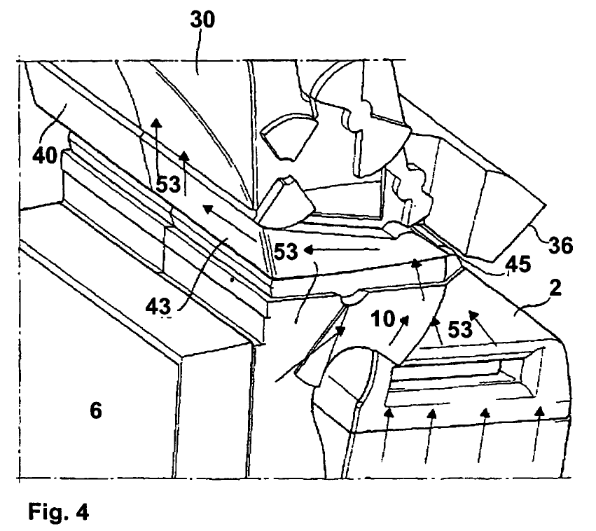

FIG. 2 shows the flow course 53 in the hot air flow path 16 over the heat exchanger 5 up to the casing opening 41 in the inflow region of the hot air channel 40. FIG. 4 shows the further flow course 53 through the hot air channel up to the distribution casing 30, whereby the flow course 53 of the hot air is represented in form of flow vectors.

The device 1 according to the invention is provided in addition to the separate hot air channel 40, with a separate cold air bypass channel 50 with an inlet opening 51 and an outlet 52 which runs inside the casing 2. It is understood that the channel 50 can be sized or tuned to control the amount of air permitted to flow therethrough. This can be accomplished through hydraulic diameter sizing, orifices (not shown), or tuning valves or dampers (not shown), for example. The flow course 54 in the cold air flow path 17 over the evaporator 8 to the inlet opening 51 of the separate cold air channel is shown in FIG. 2 also by means of flow lines. The inlet opening 51 of the 50 is positioned adjacent to the evaporator 8 at the level of the air outlet region 10 and hence can directly take a portion of the air cooled at the outside of the evaporator 8 and direct it to the instrument panel outlet 34.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A device for tempering and ventilating of motor vehicles with an air inlet opening and an air outlet region, from which air flows are distributed into different vehicle regions by a distribution casing, the device comprising:
a hollow casing having a partition disposed therein to divide a flow path of air from the air inlet opening to the air outlet region into a first flow path and a second flow path;
an evaporator disposed in said casing upstream of the partition;
a heat exchanger disposed in the first flow path to heat air flowing through the first flow path;
a temperature door disposed in said casing to selectively control flow of air through the first flow path and the second flow path;
a hot air bypass channel formed on said casing adjacent the air outlet region and upstream of the distribution casing, said hot air bypass channel having an inlet opening and an outlet opening formed therein, the inlet opening in fluid communication with the air outlet region and the outlet opening in fluid communication with the distribution casing adjacent a defroster outlet of said casing; and
a cold air bypass channel formed in said casing, said cold air bypass channel having an inlet opening adjacent said evaporator and an outlet opening adjacent an instrument panel outlet of said casing.

2. The device according to claim 1, wherein said temperature door is disposed downstream of the partition.

3. The device according to claim 2, wherein said temperature door is angled towards the partition.

4. The device according to claim 2, wherein said temperature door has a concave curve facing towards the partition such that at end stop positions, one of the first flow path and the second flow path is closed, and at an intermediate position, air of the first flow path is at least partially directed into air of the second flow path.

5. The device according to claim 1, wherein an air guide plate having a bend in a direction of flow is arranged upstream of the partition such that it divides the first flow path into two flow paths.

6. The device according to claim 1, wherein up to three walls of the hot air bypass channel and the cold air bypass channel form part of the case, wherein additional covers complete said hot air bypass channel and said cold air bypass channel.

7. The device according to claim 1, wherein said hot air bypass channel is substantially U-shaped.

8. The device according to claim 1, wherein said hot air bypass channel includes a pair of inlets.

9. The device according to claim 1, wherein the outlet of said hot air bypass channel is positioned in a base portion of the U-shape.

10. The device according to claim 1, wherein said hot air bypass channel is tunable.

11. The device according to claim 1, wherein said cold air bypass channel is tunable.
